(19) United States
(12) Patent Application Publication
(10) Pub. No.: US 2010/0116951 A1
(43) Pub. Date: May 13, 2010

(54) COMBINATION STAND AND SIGN HOLDER

(76) Inventor: James Bifulco, Staten Island, NY (US)

Correspondence Address: ROBERTS & ROBERTS, LLP;ATTORNEYS AT LAW, P.O. BOX 484, PRINCETON, NJ, 08542-0484, US

(21) Appl. No.: 12/266,945

(22) Filed: Nov. 7, 2008

(51) Int. Cl. F16M 13/00; F16M 11/24; G09F 11/00

(52) U.S. Cl. 248/146; 248/158; 248/161; 40/1

(57) ABSTRACT

A combination stand and sign holder capable of supporting an object such as a fire extinguisher, as well as holding at least one sign thereon. The combination may be used to provide fire extinguishers or other safety components, as well as instructional signs or exit information, in compliance with safety regulations at construction sites and the like.

### BACKGROUND OF THE INVENTION

1. Field of the Invention

The present invention relates to a combination stand and sign holder. In particular, it relates to a combination stand and sign holder capable of supporting an object such as a fire extinguisher, as well as holding and displaying at least one sign thereon. The combination may be used to provide fire extinguishers or other safety components, as well as instructional signs or exit information, in compliance with safety regulations at construction sites and the like.

2. Description of the Related Art

Federal, state, and local safety regulations often provide specific requirements regarding the presence of fire prevention and safety equipment, such as fire extinguishers and the like, at a construction site. These regulations may require certain numbers of fire extinguishers relating to square footage of the site, specific location or height requirements for safety equipment, and signage requirements relating to exit notifications or safety procedures and instructions.

While a variety of fire extinguisher housings are known, many these structures are designed to be attached onto a wall or the like. For instance, U.S. Pat. No. 5,195,595 and U.S. Pat. No. 5,975,475 both each show a fire extinguisher holder or casing which is to be screwed or bolted to a wall. However, in certain construction environments walls are not yet in place, or it may not be practical to bolt such a holder or casing to a temporary structure. In fact, in situations where ongoing construction necessitates the moving of a fire extinguisher other safety station to a different location within the construction site, such holders or casings must be unbolted from the first wall, and then bolted to a different wall at a different location. This results in expenditures of money and time which must be accounted for in the overall construction project. A need therefore exists for a portable and easily accessible safety equipment station for use at construction sites or in other environments.

The present invention provides a solution to these problems. It provides a combination stand and sign holder which can be easily moved throughout a construction site, and which does not have to be fixedly installed, removed, and reinstalled as construction progresses. The combination stand and sign holder generally includes a sturdy base, a shaft or rod coupled to the base and extending vertically upward from the base, a display module coupled to the shaft for holding a sign thereon, and a mounting member of the shaft, which mounting member is capable of supporting an object such as a fire extinguisher thereon. The mounting member may be a hook or the like, and the shaft is preferably adjustable in height, so that the height of the sign and/or the fire extinguisher may be adjusted to comply with safety regulations.

The combination is sturdy enough to withstand the rigors of a construction site, as well as to support an object such as a fire extinguisher, fire hose, eye wash station, or the like, anywhere on the construction site. The combination is further capable of holding and displaying signs, such as important directional or instructional signage which may provide emergency messages, exit information, or safety regulatory information and protocols, as required at most sites. The signage may also serve as a reflective or photoluminescent locator. Another advantage of the invention is that it is easily assembled from its component parts, and easily disassembled for storage.

Although some fire extinguisher holders have been developed which are intended to be portable, none of them have the above desired features of the present invention. U.S. Pat. No. 4,303,218 relates to a portable fire extinguisher support. This structure has a single sloped wall which is continuous with a base portion and a top hanger portion for hanging a fire extinguisher via a top bracket. U.S. Design Pat. No. D522,180 shows an ornamental design for a fire extinguisher holder. This patent simply provides a structure in the shape of a sleeve-like holder for standing a fire extinguisher therein. Neither of these disclose the inventive structure having a vertical shaft which is removably coupleable to a base, a display module coupleable to the shaft, which display module holds a sign, and the wherein the shaft may be adjustable in length for changing the height of the fire extinguisher thereon and/or the height of a sign on the display module. U.S. Pat. No. 7,171,736 relates to a method for assembling a portable stand for fire extinguishers. However the stand of this disclosure merely provides a shell-like a case for housing a fire extinguisher, which case is mounted to a pylon. This stand does not teach the presence of a display module for holding and displaying a sign. In addition, this patent does not teach or suggest that their pylon may be adjustable in length, for changing the height of the fire extinguisher within their case.

In addition, while several sign holders and displays are known in the art, none teach the structure or the desired features and benefits of the present invention. The sign holder of U.S. Pat. No. 4,917,342 discloses a stand made of a plastic sheet material, which is used to hold pricing signs in bakeries or supermarkets and the like. There is no teaching in this patent of a shaft having a mounting member which can support an object thereon. Additionally, their sign holder does not contain parts which are removably coupleable as presently disclosed. The disclosure also fails to teach or suggest that their stem may be adjustable in length, for adjusting the height of their sign. U.S. Pat. No. 7,140,581 discloses a portable stand for supporting a sign. This stand structure has a base, a post, and a pair of windowed frames for holding signs therein. However, this patent does not disclose a mounting member attached to the shaft, for supporting an object such as a fire extinguisher thereon. This patent likewise does not teach that their parts are removably coupleable, and does not teach or suggest that their post may be adjustable in length, for adjusting the height of their sign.

The inventive combination stand and sign holder offers an inexpensive, convenient, portable, and reliable means for providing required equipment and signage at a construction site, in compliance with federal, state, and local safety regulations.

### SUMMARY OF THE INVENTION

The invention provides a combination stand and sign holder, comprising:

(a) a base;

(b) a shaft coupler attached to the base;

(c) a shaft having a first end and a second end, the first end of the shaft being removably coupleable to the base via the shaft coupler such that the shaft extends vertically upward from the base;

(d) a display module coupleable to the shaft, which display module is capable of holding a sign thereon; and

(e) a mounting member attached to the shaft, which mounting member is capable of supporting an object thereon.

The invention also provides a method of displaying an object, comprising the steps of:

I) providing a combination stand and sign holder which comprises:
(a) a base;
(b) a shaft coupler attached to the base;
(c) a shaft having a first end and a second end, the first end of the shaft being removably coupled to the base via the shaft coupler such that the shaft extends vertically upward from the base;
(d) a display module coupled to the shaft, which display module is capable of holding a sign thereon;
(e) a mounting member attached to the shaft, which mounting member is capable of supporting an object thereon; and

II) conducting at least one of the following steps:
a) mounting an object to the mounting member, such that the object is supported on the mounting member; and/or
b) holding at least one sign on the display module.

The invention further provides a method of assembling a combination stand and sign holder, comprising the steps of:

(I) providing components of a combination stand and sign holder which include:
(a) a base;
(b) a shaft coupler attached to the base;
(c) a shaft having a first end and a second end, the first end of the shaft being removably coupleable to the base via the shaft coupler such that the shaft extends vertically upward from the base;
(d) a display module coupleable to the shaft, which display module is capable of holding a sign thereon;
(e) a mounting member attached to the shaft, which mounting member is capable of supporting an object thereon; and

(II) assembling the combination stand and sign holder, via the steps of: removably coupling the first end of the shaft to the base via the shaft coupler such that the shaft extends vertically upward from the base; and coupling the display module to the shaft.

### BRIEF DESCRIPTION OF THE DRAWINGS

FIG. 1 shows a front perspective view of the combination stand and sign holder of the invention.

FIG. 2 shows a front view of the combination stand and sign holder of the invention in use, having a fire extinguisher supported by the mounting member, and instructional signs attached to the display module.

### DETAILED DESCRIPTION OF THE INVENTION

A combination stand and sign holder is provided, and is hereinafter referred to as the “combination”. The inventive combination is portable, easily movable, and readily assemblable and disassemblable. The combination is capable of supporting an object such as a fire extinguisher, as well as holding and displaying at least one sign such as an instructional sign. In certain embodiments, the stand may be used to provide fire extinguishers or other safety components, as well as instructional safety signs or other information, at construction sites and the like.

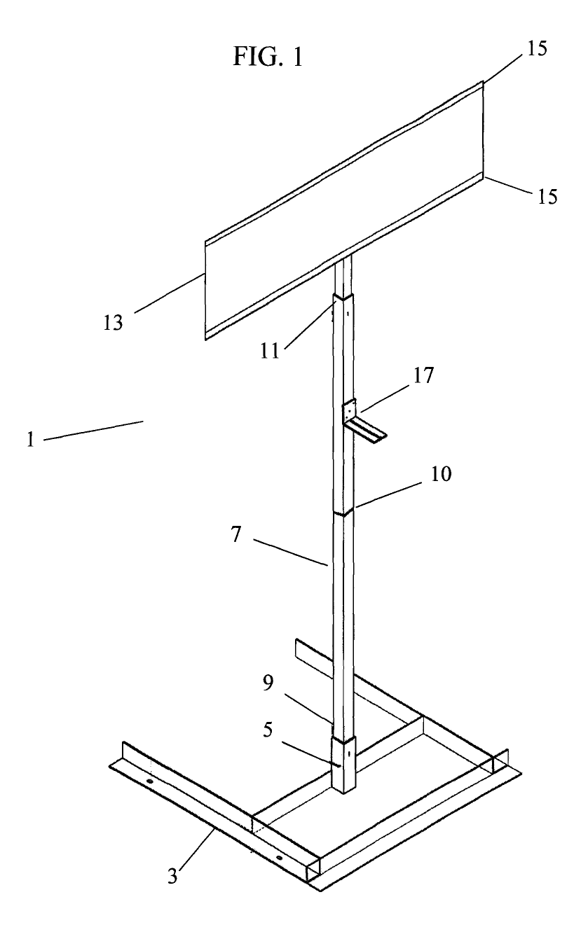

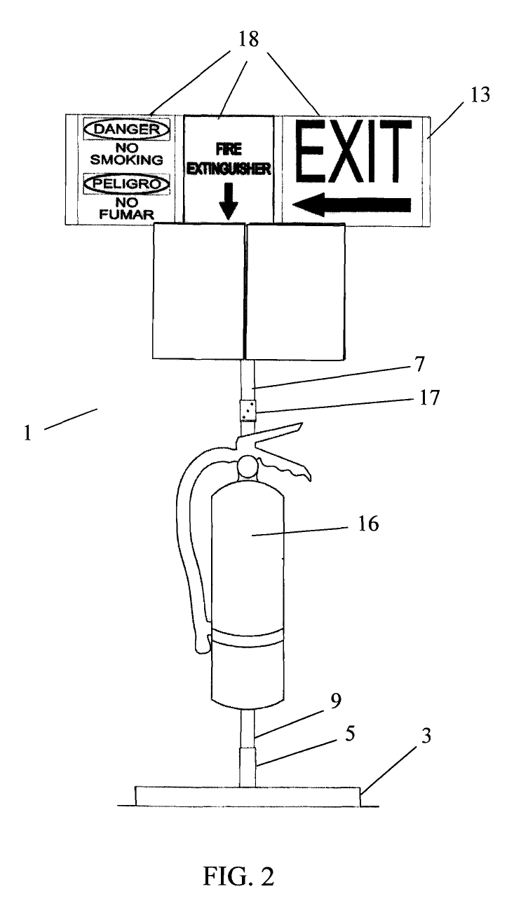

The inventive combination stand and sign holder 1, shown in FIGS. 1 and 2, comprises a base 3. Suitable materials for the base 3 as well as other components of the combination 1 are described in detail below. The base 3 may comprise any shape, size, or configuration suitable to provide stable support for the weight of the overall combination 1, and such that the combination 1 is capable of standing in an upright assembled position as shown in FIG. 1. In certain embodiments, the base comprises a plurality of stabilizing legs. In certain embodiments, the base comprises a substantially flat support panel optionally having a stabilizing leg attached to the support panel. In certain embodiments, a stabilizing leg comprises an angled bar comprising two substantially flat elongated members which are attached to each other along a lengthwise edge, at substantially a 90 degree angle with respect to each other.

The combination 1 next includes a shaft coupler 5 attached to the base 3. The shaft coupler 5 may comprise any shape, size, or configuration such as a sleeve, slot, casing, or any other known coupling means, which is suitable for coupling a shaft, as described below, to the base 3. In certain embodiments, the shaft coupler comprises a female component such as a sleeve, which is mateably coupleable with a male end of the shaft. In other embodiments, the shaft coupler comprises a male component such as a post, which is mateably coupleable with a female end of the shaft. The shaft coupler 5 may be attached to the base in any suitable manner. In certain embodiments, the shaft coupler 5 is fixably attached to the base, such as by welding. The shaft coupler 5 may even be an integral component of the base 3. In other embodiments, the shaft coupler 5 is removably attached to the base, such as via a wing nut screw, a bolt, or the like. In certain embodiments, the shaft coupler and/or the shaft may comprise a locking mechanism for locking the shaft coupler and the shaft together. Suitable materials for the shaft coupler 5 as well as other components of the combination 1 are described in detail below.

The combination 1 further includes a shaft 7, having a first end 9 and a second end 11. The first end 9 of the shaft 7 is removably coupleable to the base 3 via the shaft coupler 5, such that the shaft 7 extends vertically upward from the base 3. The shaft 7 may be removably coupled to the base via the shaft coupler using any suitable means, such as via a wing nut screw, a bolt, or the like. In certain embodiments, the shaft 7 and the shaft coupler are slidably coupled together. In certain embodiments, the first end 9 of the shaft 7 may be in the form of a male component such as a post, or female component such as a sleeve, which is mateably couplable with an oppositely shaped shaft coupler 5 as described above. As described below, the combination 1 further comprises a display module which is couplable to the shaft 7. The display module may be coupleable at the second end 11 of the shaft 7, or at a location between the first end 9 and the second end of 11 of the shaft 7. Thus, in certain embodiments the second end 11 of shaft 7 may be in the form of a male or female component which is mateably couplable with a display module, as described below.

Suitable materials for the shaft 7 as well as other components of the combination 1 are described in detail below. The shaft 7 may be solid or hollow in shape, and may have any suitable cross sectional shape such as circular, square, triangular, or the like. The shaft 7 may comprise any suitable length, width, or diameter as deemed necessary for its intended use In certain embodiments, it is preferred that the shaft 7 is adjustable in length. That is, the length of the shaft 7 may be adjusted at either or both of its ends 9 and 11, or at an intermediate joint 10 or the like which is present between the first end 9 and the second end of 11 of the shaft 7. It may be desirable to adjust the length of the shaft 7 such that the height of an object supported thereon by the mounting member, described below, may be adjusted. It may be desirable to adjust the length of the shaft such that the height of the display module and/or the height of a sign held by the display module coupled to the shaft 7, as described below, may be adjusted. The adjustability of the shaft 7 may assist in compliance with safety regulations which require that an object such as a fire extinguisher, or a sign with safety regulations, be present at a construction site or the like at a particular height.

The combination 1 further comprises a display module 13 which is coupleable to the shaft 7, and which display module 13 is capable of holding a sign thereon. In certain embodiments, the display module 13 is removably coupleable to the shaft 7. The display module may be coupled to the shaft at or near the second end 11 of the shaft 7, or at a location between the first end 9 and the second end of 11 of the shaft 7. As stated above, the display module 13 may comprise a male or female component which is mateably couplable with a corresponding male or female component of the second end 11 of the shaft 7. The display module 13 may be removably coupled to the shaft using any suitable means, such as via a wing nut screw, a bolt, or the like. In certain embodiments, the display module 13 and the shaft 7 are slidably coupled together. In certain embodiments, the display module 13 is pivotably coupled to the shaft.

The display module 13 may comprise any shape, size, or configuration suitable to hold and display a sign thereon. In certain embodiments, the display module comprises a substantially flat panel. The display module may comprise a post or the like which may be adjustable in length, such that such that the height of the display module and/or the height of a sign held by the display module 13 may be adjusted. In certain embodiments, one or more signs may be held to the display module 13 using any suitable means, such as hook and loop closures, clips, tape, glue, tacks, nails, screws, and the like. In certain embodiments, the display module 13 comprises at least one grooved channel 15 for slidably holding a sign to the display module. In such an embodiment, a sign is slidably inserted into the grooved channel such that it is held on the display module via the channel. Examples of such signs are described below. In certain embodiments, the display module and/or the shaft may comprise a locking mechanism for locking the display module 13 and the shaft 7 together. Suitable materials for the display module 13 as well as other components of the combination 1 are described in detail below.

The combination 1 next comprises a mounting member 17 attached to the shaft 7, which mounting member is capable of supporting an object thereon. The mounting member 17 may comprise any shape, size, or configuration suitable for supporting an object thereon. Examples of such objects are described below. In certain embodiments, the mounting member 17 comprises a hook. In certain embodiments, the mounting member 17 is attached between the first end 9 and the second end of 11 of the shaft 7. In certain embodiments, the mounting member 17 may be fixedly attached to the shaft 7, such as by welding or the like. In other embodiments, the mounting member 17 may be removably attached to the shaft 7, such as via a wing nut screw, a bolt, or the like. In certain embodiments, it may be desired that the height of the mounting member is adjustable. This may be done either by removing and reattaching the mounting member to the shaft at a different height, or by adjusting the height of the shaft 7 as described above. Suitable materials for the display module 13 as well as other components of the combination 1 are described in detail below.

The materials for the base, the shaft coupler, the shaft, the display module, and the mounting member may comprise any suitable material such as metal or a plastic. The materials for the base, the shaft coupler, the shaft, the display module, and the mounting member may or may not comprise substantially the same material. In one embodiment, each of the base, the shaft coupler, the shaft, the display module, and the mounting member independently comprise a substantially non-combustible material. Examples of suitable materials which may be independently selected for each of the base, shaft coupler, shaft, display module, and mounting member, nonexclusively include metals such as iron, aluminum, steel including stainless steel, and combinations and alloys thereof.

In its assembled form, the combination 1 is arranged such that the first end 9 of the shaft 7 is coupled to the base via the shaft coupler 5, the display module 13 is coupled to the shaft 7. Further, an object is supported on the mounting member 17. Regarding the type of object to be supported on the mounting member 17, it should be noted that the combination stand and sign holder of this invention may be used to support a great variety of objects in a variety of environments. The combination is particularly suited for construction sites and/or other environments where safety equipment and safety instructions are desired or even required. Thus, the combination 1 may be used to support one or more safety related objects, such as a fire extinguisher, a fire hose, first aid equipment, eye wash equipment, emergency communication equipment, and the like. In certain embodiments of this invention, an object supported on the mounting member comprises a fire extinguisher such as 16..

Further, in certain embodiments, at least one sign 18 is held by the display module of the inventive combination. In still other embodiments, an object supported on the mounting member comprises a fire extinguisher and, additionally, at least one sign is held by the display module. Any type of sign containing any desired message or information may be held on and displayed by the display module 13. The sign's information or message may or may not be related to the object supported by the mounting member. For instance, a sign 18 held on the display module 13 may include instructions relating to a fire extinguisher which is being supported by the mounting member 17. In fact, certain fire code regulations require that instructional signs are placed within a certain proximity to a fire extinguisher. The present invention allows for compliance with such regulations. Furthermore, the height of the instructional signs and/or the fire extinguisher may be subject to certain fire code regulations as well. Thus, the length of the shaft 7 and/or components display module 13 may be adjusted as described above, in order to comply with such height regulations. In addition, other safety signs such as exit signs, evacuation plans, signs warning against smoking, and the like, may be held by the display module 13. Certain signs 18 may be reflective and/or photoluminescent, and may serve as locators for the combination and those objects supported thereon, such as a fire extinguisher or the like.

This invention also relates to a method of displaying an object. Examples of such objects nonexclusively include those described above, such as a fire extinguisher 16. The method first includes the step of providing a combination stand and sign holder 1, as described in full detail above, and which combination 1 is in assembled form. That is, the assembled combination 1 comprises a base; a shaft coupler attached to the base; a shaft having a first end and a second end, the first end of the shaft being removably coupled to the base via the shaft coupler such that the shaft extends vertically upward from the base; a display module coupled to the shaft, which display module is capable of holding a sign thereon; and a mounting member attached to the shaft, which mounting member is capable of supporting an object thereon. For illustrative purposes, the combination stand and sign holder of the presently described method, in assembled form, may be visually represented by the combination 1 shown in FIGS. 1 and 2.

Next, the inventive method comprises the conducting of at least one of the following steps: a) mounting an object to the mounting member, such that the object is supported on the mounting member; and/or b) holding at least one sign on the display module. That is, in certain embodiments, an object is mounted on the mounting member, but a sign is not held on the display module. In other embodiments, an object is not mounted to the mounting member, but at least one sign is held on the display module. In still other embodiments, an object is mounted on the mounting member, and at least one sign is held on the display module. Furthermore, in certain embodiments wherein an object is mounted to the mounting member, the object comprises a fire extinguisher 16.

This invention further relates to a method of assembling a combination stand and sign holder 1 of the invention. The method first includes the step of providing the components of a combination stand and sign holder, as described in full detail above, wherein the components of combination 1 are not in assembled form. That is, the components comprises a base; a shaft coupler attached to the base; a shaft having a first end and a second end, the first end of the shaft being removably coupleable to the base via the shaft coupler such that the shaft extends vertically upward from the base; a display module coupleable to the shaft, which display module is capable of holding a sign thereon; and a mounting member attached to the shaft, which mounting member is capable of supporting an object thereon.

Next, the inventive method comprises the step of assembling the combination stand and sign holder, via the steps of: removably coupling the first end of the shaft to the base via the shaft coupler such that the shaft extends vertically upward from the base; and coupling the display module to the shaft.

In certain embodiments, this method further comprises the step of holding at least one sign 18 on the display module 13. In certain embodiments, the method further comprises the subsequent step of mounting an object to the shaft via the mounting member, such that the object is supported on the mounting member. In embodiments where an object is mounted to the shaft via the mounting member, the object may comprises a fire extinguisher.

Furthermore, in certain embodiments, the method further comprises the subsequent step of disassembling the combination stand and sign holder.

The combination stand and sign holders of the invention may be used for a variety of purposes and in a variety of environments such as construction sites, schools, office buildings, museums, airports, train stations, stadiums, arenas, parks and outdoor venues, military locations, and the like. The inventive combination may be used to support any suitable object, and hold any suitable signs having any desired message or information, as deemed necessary by a user.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A combination stand and sign holder, comprising:
(a) a base;
(b) a shaft coupler attached to the base;
(c) a shaft having a first end and a second end, the first end of the shaft being removably coupleable to the base via the shaft coupler such that the shaft extends vertically upward from the base;
(d) a display module coupleable to the shaft, which display module is capable of holding a sign thereon; and
(e) a mounting member attached to the shaft, which mounting member is capable of supporting an object thereon.

2. The combination stand and sign holder of claim 1 wherein the shaft is adjustable in length.

3. The combination stand and sign holder of claim 1 wherein each of the base, the shaft coupler, the shaft, the display module, and the mounting member independently comprise a substantially non-combustible material.

4. The combination stand and sign holder of claim 1, wherein each of the base, the shaft coupler, the vertical shaft, the display module, and the mounting member comprise steel.

5. The combination stand and sign holder of claim 1, wherein said display module comprises at least one grooved channel for slidably holding a sign to the display module.

6. The combination stand and sign holder of claim 1, wherein the mounting member comprises a hook.

7. The combination stand and sign holder of claim 1 wherein the mounting member is removably attached to the shaft.

8. The combination stand and sign holder of claim 1 wherein the mounting member is attached between the first end and the second end of the shaft.

9. The combination stand and sign holder of claim 1 wherein the display module is removably coupleable to the second end of the shaft.

10. The combination stand and sign holder of claim 1, wherein the display module comprises a substantially flat panel.

11. The combination stand and sign holder of claim 1, wherein the first end of the shaft is coupled to the base via the shaft coupler, the display module is coupled to the shaft, and an object is supported on the mounting member.

12. The combination stand and sign holder of claim 11 wherein the object comprises a fire extinguisher.

13. The combination stand and sign holder of claim 11 further comprising at least one sign held by the display module.

14. The combination stand and sign holder of claim 11 wherein the display module is pivotably coupled to the shaft.

15. A method of displaying an object, comprising the steps of:
I) providing a combination stand and sign holder which comprises:
(a) a base;
(b) a shaft coupler attached to the base;
(c) a shaft having a first end and a second end, the first end of the shaft being removably coupled to the base via the shaft coupler such that the shaft extends vertically upward from the base;
(d) a display module coupled to the shaft, which display module is capable of holding a sign thereon;
(e) a mounting member attached to the shaft, which mounting member is capable of supporting an object thereon; and
II) conducting at least one of the following steps:
a) mounting an object to the mounting member, such that the object is supported on the mounting member; and/or
b) holding at least one sign on the display module.

16. The method of claim 15 wherein part (a) of step (II) is conducted, and part (b) of step (II) is not conducted.

17. The method of claim 15 wherein part (a) of step (II) is conducted, and part (b) of step (II) is not conducted.

18. The method of claim 15 wherein both parts (a) and (b) of step (II) are conducted.

19. The method of claim 15 wherein the object of step (II) part (a), if present, comprises a fire extinguisher.

20. A method of assembling a combination stand and sign holder, comprising the steps of:
(I) providing components of a combination stand and sign holder which include:
(a) a base;
(b) a shaft coupler attached to the base;
(c) a shaft having a first end and a second end, the first end of the shaft being removably coupleable to the base via the shaft coupler such that the shaft extends vertically upward from the base;
(d) a display module coupleable to the shaft, which display module is capable of holding a sign thereon;
(e) a mounting member attached to the shaft, which mounting member is capable of supporting an object thereon; and
(II) assembling the combination stand and sign holder, via the steps of: removably coupling the first end of the shaft to the base via the shaft coupler such that the shaft extends vertically upward from the base; and coupling the display module to the shaft.

21. The method of claim 20 further comprising the step of holding at least one sign on the display module.

22. The method of claim 20 further comprising the subsequent step of mounting an object to the shaft via the mounting member, such that the object is supported on the mounting member.

23. The method of claim 22 wherein the object comprises a fire extinguisher.

24. The method of claim 20 further comprising the subsequent step of disassembling the combination stand and sign holder.
